(19) United States
(12) Patent Application Publication
(10) Pub. No.: US 2019/0241046 A1
(43) Pub. Date: Aug. 8, 2019

(54) Extendable Air Outlet Device embed an extendable wind tunnel tube system to use air condition system as Dryer In The Vehicle and Transportation

(71) Applicant: Hsien-Hsiang Chiu, Branchton (CA)

(72) Inventor: Hsien-Hsiang Chiu, Branchton (CA)

(21) Appl. No.: 15/886,867

(22) Filed: Feb. 2, 2018

(51) Int. Cl. B60H 1/34; F26B 21/00

(52) U.S. Cl. CPC B60H 1/3428; B60H 2001/3492; F26B 21/004

(57) ABSTRACT

Extendable Air Outlet Device to redistribute air outlet's blow directions the cold or hot air from air condition system to allow passenger use as Dryer In The Vehicle, Transportation. The device has embed an extendable wind tunnel tube system to allow passenger pulling out the 1st air outlet front section from the air outlet's body chamber, and passenger moving the front section freely blow air any direction on surrounding area, head, face, shoulder and especially passenger in sitting position, the device can directly blow hot or cold air on passenger body's under belly area and between legs, lower body locations where normal vehicle fixed style air outlet are not able to. 2 styles Extendable Air Outlet Device can be build as portable platform that attached on air outlet as external attachment device, and manufacture new outlet device use as dryer system for self driving car passengers needs.

### BACKGROUND OF THE INVENTION

### Field of the Invention

This invention relates to using an Extendable Air Outlet Device to redistribute air outlet's blow directions the cold or hot air from vehicle's air condition system to allow passenger use the Extendable Air Outlet Device as Dryer In The Vehicle and Transportation. The device has assembled into 4 sections parts and inside the device has embed an extendable wind tunnel tube system (the 3rd assembled section parts) to allow passenger pulling out the 1st air outlet front louver unit (the 1st assembled section parts) departed from the air outlet's main outer shell body's chamber space (the 2nd assembled section parts), and then passenger can moving the 1st air outlet front louver unit freely to blow air in any direction on surrounding area, head, face, shoulder and especially while the passenger is in sitting position, the device can freely moving closed to and point directly to blow hot or cold air on passenger body's under belly area and between legs, lower body locations where normal vehicle fixed style air outlet louvers are not able to so. There are 2 styles of Extendable Air Outlet Device can be build, the 1st style is as portable platform that attached on air outlet as external attachment device, and also the 2nd style is the device can be manufacture a new type of the air outlet device use to covert the vehicle's air condition system as Dryer In The Vehicle and provide the comfortable accessory features conveniences for the self driving vehicle passengers.

### BACKGROUND ART

Currently, the vehicle air outlet is fixed installed on the driving control panel, and the air outlet has design with louver at front surface, and the fixed air outlet blow direction has the limitation area. The fixed air outlet can not direct blow on passenger body's under belly area and between legs, lower body locations.

There are any occasions situations that passengers might wish to have the solution.

For example, when you in raining day, you have enter your car, and your hair, cloth, pant are wet.

Sometime, you have drink water, juice, you have spit the water, juice on your pant, between legs, under belly, lower body area.

Sometime, may for reasons might healthy issue, or an unexpected traffic driving time length. You might accidentally peeing in your pant because you can not hold it while driving to your work, business meeting, or shopping, You have to let go and now your pant wet.

Sometime, you have business meeting, you are dress up, while driving you have sweat start form neck, armpit and below body area, you want to have a quick dry to make sure your out fit looks neat without having showing sweat on shirt. and collar.

Even just using blow fresh air on you to lift up your body energy level, and to cheer up yourself mind set and feel good will be total worthy.

In addition, the intelligent driving assistant vehicle, the new self driving vehicle, and autonomous driving cars are start to develop and has driving on the road, many auto companies start offer sell the self-driving cars. To vehicle passengers means the driving time is free time, and passengers can have more time to do things during traveling, watch movie, drink and maybe want to fixing their hair while traveling, or want to quick dry the gym cloth, swimming pant, or just want to have fresh cold or hot air blow on the body and face to feel good. This new Extendable Air Outlet Device can be useful and make passenger more conformable, an new vehicle accessory feature support for passengers needs.

The new Extendable Air Outlet Device can be useful in vehicles and also can be used in passenger cabins, passenger rooms of transportations such as in bus, subway, train, boat, cruise, commercial jet or private jet, spaceship.

### Problems to Solve and Benefits

1. Current, the vehicle air outlet is fixed installed on the driving control panel, and the air outlet has design with louver at front surface, and the fixed air outlet blow direction has the limitation area. The fixed air outlet can not direct blow on passenger body's under belly area and between legs, lower body locations.
2. There are any occasions situations that passengers might wish to have the solution.

For example, when you in raining day, you have enter your car, and your hair, cloth, pant are wet.

Sometime, you have drink water, juice, you have spit the water, juice on your pant, between legs, under belly, lower body area.

Sometime, may for reasons might healthy issue, or an unexpected traffic driving time length. You might accidentally peeing in your pant.

Sometime, you have business meeting, you are dress up, while driving you have sweat start form neck, armpit and below body area, you want to have a quick dry to make sure your out fit looks neat without having showing sweat on shirt. and collar. Even just want blow fresh air on you to lift up your body energy level, and to cheer up yourself mind set and feel good will be total worthy.

Sometime, you have work out after gym, your outfit is wet, and you want to have quick dry outfit cloth before you go to super market for grocery shopping or Startbucks for a strawberry protein shake.

Sometime, in most passengers experiences are often to have want to have the solution, not for themselves but for their love ones; for example kids just split juice on their cloth, pant and seat, mother would definitely want to apply paper tower to dry it but not efficient dry enough, and how about if she can reach the air outlet use as dryer to take care of the situation?

What if children are car sick, and vomit and accidentally split some waste on cloth, seat, and still having vomit waste on their face situation, after wiping clean, would it be great to reach air outlet to use blow fresh cold air on children and yourself face, refresh the surround air around.

3. In winter time, when enter car, it is like inside refrigerator, you can pulling out the 1st air outlet louver front unit to blow hot air on your body, hands to make you feeling warmer, and car chairs, seat, driving wheel, objects in the area, and may vehicle windows still some ice left need to be melt.
4. In summer time, when you enter into car that in parking lot, it feels like oven, sitting on the hot seat and begin sweating right start, you might gladly to have able pulling out the 1st air out louver front unit and having cold air condition air to blow directly on you and seat to cool down the temperature faster.
5. New Extendable Air Outlet Device can be useful and make passenger more conformable, an new self driving vehicle accessory feature support for passengers needs. Passengers maybe want to fixing their hair while traveling, or want to dry the gym cloth, swimming pant more quickly, or passengers just want to have fresh cold or hot air direct blow on the body and face to feel good.

### SUMMARY OF THE INVENTION

The above problems are solved by the present invention of Extendable Air Outlet Device. To solve problems and improve a better way device to redistribute air outlet's blow directions the cold or hot air from vehicle air condition system using as Dryer In The Vehicle and Transportation.

I have purpose the Extendable Air Outlet Device that allow vehicle passengers conveniences to hand hold the 1st air outlet front louver unit to moving in comfortable area and freely to blow air in any direction on surrounding area, chairs, sits, vehicle windows, and passenger body, head, face, shoulder and especially while the passenger is in sitting position, the device can freely moving closed to and point directly to blow hot or cold air on passenger body's under belly area and between legs, lower body locations where normal vehicle fixed style air outlet louvers are not able to so.

In addition, my proposal Extendable Air Outlet Device can be useful and make passenger more conformable and conveyance, an new self driving vehicle accessory feature support for passengers needs. Passengers maybe want to fixing their hair while traveling, or want to dry the gym cloth, swimming pant more quickly, or passengers just want to have fresh cold or hot air direct blow on the body and face to feel good.

Current regular fixed installed air outlet methods are not able to support function like use as dryer and because it is fixed installed has its limitation on air flow blow directions, for fixed air outlet installed on are mainly use to change he vehicle room temperature even with louver design it only can blow on certain body areas head, face, shoulder, and feet's, in order to have direct blow on hair, passenger must do awaked leaning forward body gesture and circling moving their head, face or arms toward the air outlet fixed installed on the driving control panel surface to dry and its is uncomfortable body gesture for passengers to do that especially when in sitting position. Even passenger trying to lean forward still not able to have freely blow air right on the lower body area, between legs area. Therefore, passenger need and enduring inconveniences to wait for the discomfort to get over with it during the traveling. There are many situations and reasons that passengers does required to have dryer in vehicle. In most passengers during driving experiences are often to have want to have the solution, for example kids just split juice on their cloth, pant and seat, mother would definitely want to apply paper tower to dry it but not efficient dry enough, and how about if she can reach the air outlet use as dryer to take care of the situation? The current air outlet could not do, so passengers have to wait, and endure the inconveniences. What if children are car sick, and vomit and accidentally split some waste on cloth, seat, and still having vomit waste on their face situation, after wiping clean, happens all the time, would it be great to reach air outlet to use blow fresh cold air on children and yourself face, cloth and refresh the surround air around. These are the current traditional fixed installed air outlet systems limitations and the reasons why need to have my proposal Extendable Air Outlet Device embed an extendable wind tunnel tube system to use vehicle's air condition system as Dryer In The Vehicle.

In summary my proposal invention of Extendable Air Outlet Device is to redistribute air outlet's blow directions the cold or hot air from vehicle air condition system using as Dryer In The Vehicle and Transportation enable passengers to have conveniences and comfortable experience during traveling.

There are 2 styles of Extendable Air Outlet Device can be build, the 1st style is as portable platform that attached on air outlet as external attachment device, and also the 2nd style is the device can be manufacture a new type of the air outlet device use to covert the vehicle's air condition system as Dryer In The Vehicle and provide the conveniences and comfortable accessory features for the self driving vehicle passengers. The new Extendable Air Outlet Device and Potable Extendable Air Outlet Device can be useful in vehicles and also can be used in passenger cabins, passenger rooms of transportations such as in bus, subway, train, boat, cruise, commercial jet or private jet, spaceship.

### BRIEF DESCRIPTION OF THE DRAWINGS

In the drawings,

FIG. 1 is a drawing showing the regular air outlet with louver design that fixed installed on driving control panel with limitation of air blow directions on passenger body while they are in sitting position.

FIG. 2 is a drawing showing the completion of Extendable Air Outlet Device embed an extendable wind tunnel tube system to use vehicle's air condition system as Dryer In The Vehicle. The Extendable Air Outlet Device can be moving 1st air outlet section unit freely as Dryer In Vehicle and directly air blow on any directions surround area and also on passenger whole body area while they are in sitting position.

FIG. 3 is a drawing showing the details parts of the 1st air outlet louver front section unit 45.

FIG. 4 is a drawing showing the details parts of the additional air clean filter module platform 92.

FIG. 5 is a drawing showing the details parts of the additional battery powered motor fan module platform 118.

FIG. 6 is a drawing showing the details parts of the additional wind cover with adjustable smaller to larger diameter length blow mouth hole module platform 149.

FIG. 7 is a drawing showing the details parts of 2nd assemble session air outlet outer shell body 30.

FIG. 8 is a drawing showing the Helical spring that using to construct an extendable wind tunnel tube system, the 3rd assemble section components parts of the Extendable Air Outlet Device 23.

FIG. 9 is a drawing showing the Helical spring has cover material sheet 29 to be wind tunnel tube 27.

FIG. 10 is a drawing showing the details parts of the 4th assemble session bottom base platform unit 32.

FIG. 11 is a drawing showing the details parts assemble the 3rd wind tunnel tube system unit 32 with the 4th assemble session bottom base platform unit 32 and then insert into the 2nd assemble session air outlet outer shell body 30.

FIG. 12 is a drawing showing the details parts assemble The 1st air outlet louver front section unit 45 and connect helical spring wire 202 with the 3rd wind tunnel tube system unit 32 that have already installed with the 4th assemble session bottom base platform unit 32 and the 2nd assemble session air outlet outer shell body 30, to be completed Extendable Air Outlet Device 23 assembled.

FIG. 13 is a drawing showing the 2nd style of details Extendable Air Outlet Device can be build, the 2nd style is simplest method as a Portable Extendable Air Outlet Device platform that attached on air outlet as external attachment device.

FIG. 14 is a drawing showing the 2nd style of details Extendable Air Outlet Device can be build, the front base platform 287 of Portable Extendable Air Outlet Device platform that attached on wind tunnel tube 284.

FIG. 15 is a drawing showing the completion of 2nd style Portable Extendable Air Outlet Device platform that has front base platform 288 and base platform 251 in between ha attached on wind tunnel tube 284. Passenger is able to pulling out in length, and also can push back and twist action to close the device in 1 unit box.

### DETAILED DESCRIPTION OF THE PREFERRED EMBODIMENTS

In the drawings,

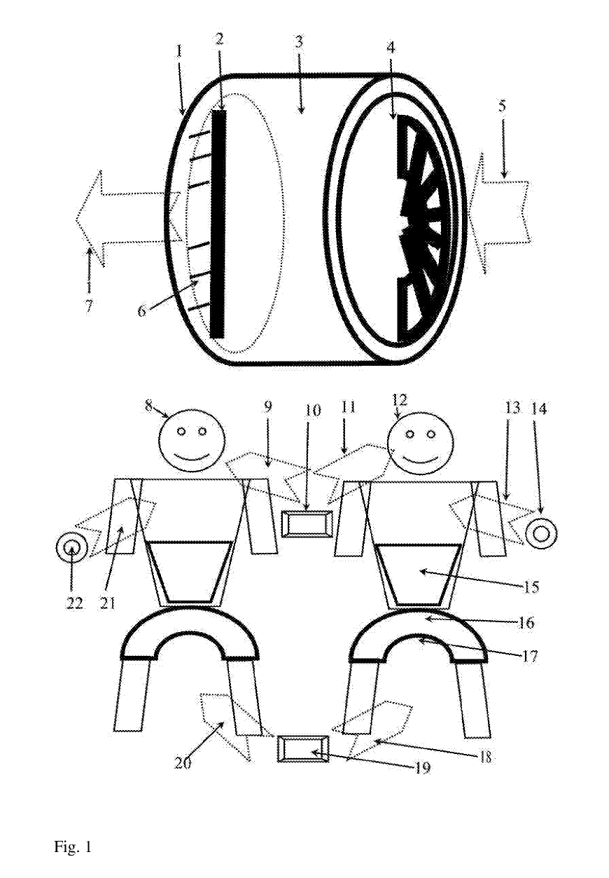

With reference to the drawings, as shown in FIG. 1 is a drawing showing the regular air outlet 1 with louver platform 6 has limitation on air flow direction range. In vehicle installed regular square shape air outlets 10 and 19, regular round shape air outlet 14 and 22 are fixed installed on driving control panel. The vehicle's air condition system air 5 into the air outlet bottom hole 4 though the empty air outlet inside space 3 and blow out the air from the front hole 2 through the louver platform 6 to vehicle air 7. Passenger 8 and 12 are sitting on seats and the air outlets 10, 14, 19, and 22 blow air out using the louver platform 6 design but still with range limitation of air blow directions 9, 11, 13, 18, 20, and 21 on passenger body areas. In order to have direct blow air flow 9, 11 on hair, passenger must do awaked leaning forward body gesture and circling moving their head, face or arms toward the air outlet 10 fixed installed on the driving control panel surface to dry and its is uncomfortable body gesture for passengers 8 and 12 to do that especially when they are in sitting position. The under air outlet 19 air flow direction 18 and 20 only good for foot area. Even passenger 8 and 12 trying to lean forward still not able to have freely blow air right on the lower body area 15, under belly area 16, and between legs area 17. The regular air outlet 1, 10, 14, 19, 22 with louver platform 6 method could not be bending the air flow to right on top of passengers body's under belly area 16 and between legs 17, and lower body locations 15 while passengers are in sitting position.

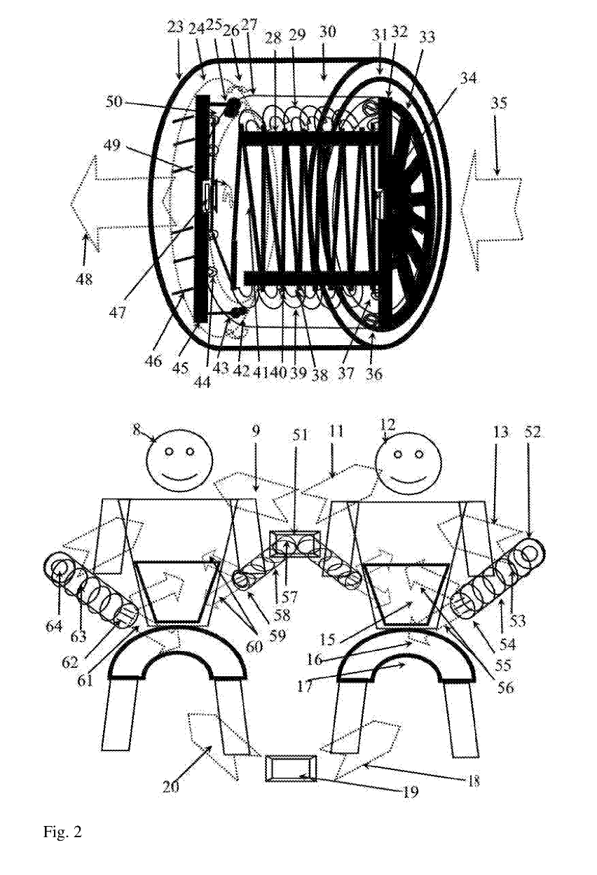

With reference to the drawings, as shown in FIG. 2 is a completion of the Extendable Air Outlet Device 23 embed an extendable wind tunnel tube system 27 to use vehicle's air condition system air 35 as Dryer In The Vehicle. The 1st air outlet section unit 45 of Extendable Air Outlet Device's 23 can be moving freely as Dryer In Vehicle and directly blow air 48 on any directions to surround area and also point on passenger whole body area while they are in sitting position

The Extendable Air Outlet Device 23 has 4 major assembled section parts.

The 1st air outlet louver front section unit 45 parts includes louver 46 at front side, locker pins 25 and 43 to insert into 2nd assemble session air outlet outer shell body 30 pin holes 26 and 42 by twist rotate action to locked or unlocked the 1st front section unit 45 and 2nd assemble session air outlet outer shell body 30.

The 2nd assemble air outlet outer shell body 30 is to hold the 1st front section unit 45, the 3rd assembled is an extendable wind tunnel tube system 27 unit and 4th bottom base platform unit 32, to assemble them all together as whole device.

The 3rd assemble session is an extendable wind tunnel tube system 27 parts includes helical spring 41 that length of spring can be pulling out to extend longer and able to retract spring back together. On the helical spring 41 has cover material sheet 29, the cover material sheet 29 can be by glue a PVC sheet, paper, elastic rubber material clothe, spandex material, or by sawing a clothe fiber, leather, or by made thin plastic layer in “U” formation attached on each spring rings. When the helical spring 41 retract back to store in the 3rd assemble session space, because the gaps space between each spring ring 38 and 40 is closer, so the cover material sheet 29 will into “U” 39 formation. The helical spring 41 can be made by metal material and plastic material. When select helical spring 41 by plastic material and the cover material sheet 29 can also use plastic too, so the wind tunnel tube can be manufactured by using 3D printing method to print the thin “U” shape 39 cover elastic plastic sheet 29 and the plastic helical spring 41 as one wind tunnel tube unit 27.

The front end of the helical spring 41 is fixed secure installed back side of the 1st air outlet louver front section unit 45, the spring wire will insert into each spring wire hook hole 44 and 50 around the unit 45 platform's back side surface, and then screw down the spring wire secure screws 47 to bite down the helical spring and secure installed with 1st unit 45.

The back end of the helical spring 41 is fixed secure installed of the front side of the 4th bottom base platform 32. The spring wire will into the spring wire hook holes 37, and then screw down the spring wire secure screws 34 to bite down the helical spring and secure installed with 4th unit.

The 4th bottom base platform unit 32 is fixed installed by screws 36 on the body shell platform end surface 31 to connect with the 2nd assemble session air outlet outer shell body 30.

The 4th bottom base platform unit 32 has unique cylinder shape pipe 28 structure design. The 3rd assemble session is an extendable wind tunnel tube system 27 parts are over around on the cylinder shape pipe 28. Therefore, The Extendable Air Outlet Device 23 is installed on driving control panel and when not being pulling out, the vehicle air condition system air 35 will come in from the bottom base hole 33 though the cylinder pipe 28 to reach out the 1st air outlet louver front section unit 45 and blow out the air 48 as normal air outlet.

When passenger unlock the 1st session locker pins 25 and 43 to pulling out the extendable wind tunnel tube system 27 with helical spring 41 with cover material sheet 29, the vehicle air condition system air 35 will pass though the cylinder pipe 28 and then travel through the extend wind tunnel tube 27 reach out the 1st air outlet louver front section unit 45 and blow out the air 48.

When passenger finished the Extendable Air Outlet Device 23 Dryer In Vehicle will put the 1st air outlet louver front section unit 45 back to 2nd assemble session air outlet outer shell body 30 storage space, the helical spring 41 will help to retract wind tunnel tube 27 back by each spring ring by ring 38 and 40 and folded the cover material sheet 29 in to “U” 39 formation and have well managed properly to store the wind tunnel tube 27 over around the cylinder pipe 28 for the next time pulling out.

The completion of Extendable Air Outlet Devices 51, 52, and 64 are installed in vehicle, vehicle cabin, vehicle passenger room, vehicle driver control panel surface. Passengers 8 and 12 can pulling out the 1st air outlet louver front section unit 55, 59, and 62. The embed wind tunnel tube 54, 58 and 63, has helical spring 53, 57 and 64 installed to enable passenger 8, 12 hand hold the 1st air outlet louver front section unit 45 moving freely in all direction and point in blow air in all body positions, include blow air right on the lower body area 15, under belly area 16, and between legs area 17 and also can point air blow to chairs, seats, windows, any objects within the wind tunnel extend reachable distance.

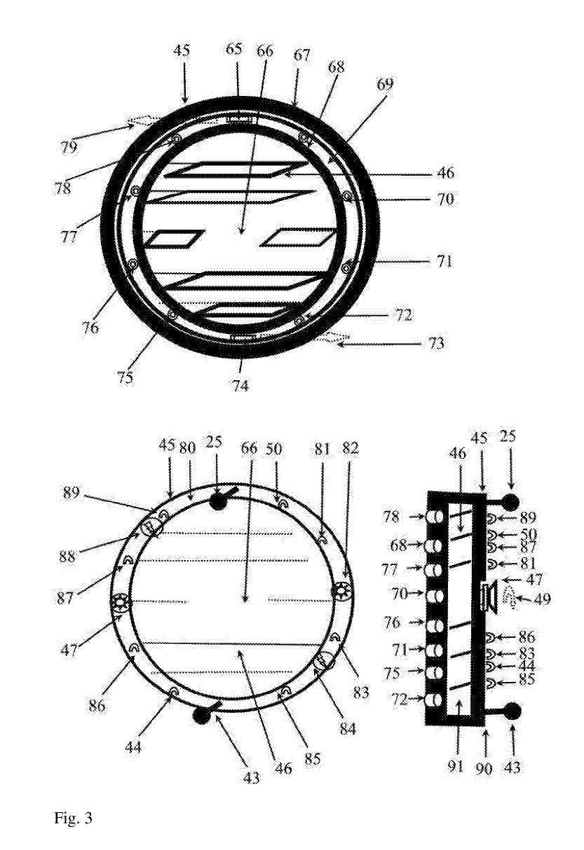

With reference to the drawings, as shown in FIG. 3 is showing the details parts of the 1st air outlet louver front section unit 45. The front view 67 of 1st air outlet louver front section unit 45. The front unit 45 has ring platform frame surface 69 and the front unit 45 has louver 46 and air flow center hole space 66.

The locker pin switchers 65, 74 to move left 79, right 73 direction to unlock the 1st air outlet louver front section unit 45 with The 2nd assemble air outlet outer shell body 30, and front section unit 45 can be pulling out. When passenger finish dry in vehicle then put front section unit 45 back to 2nd assemble session air outlet outer shell body 30 and switch locker pins 65 and 74 to secure locked.

On the ring platform frame surface 69 has Lego type of (Female) holes 68, 70, 71, 72, 75, 76, 77, 78 designed for additional accessories session units to be plug into the Lego holes and add on new system modules onto the of Extendable Air Outlet Devices.

The ring platform frame surface 69 backside surface 80 view of 1st air outlet louver front section unit 45. The locker pins 25 and 43, and the back side view of has louver 46 and air flow center hole space 66.

On backside surface 80 has included each spring wire hook holes 50, 81, 83, 85, 44, 86, 87, and 89. The spring wire secure screws 47 and 82 to screw rotation direction 49 down press secure use to bite on the spring wire. In additional, the platform 80 surface can be add using magnets 84 and 88 method to enhance the connect easier to lock and unlock action to locked or unlocked the 1st front section unit 45 and the 2nd assemble session air outlet outer shell body 30.

The side view 90 shows the ring platform frame middle layer space 91 has assembled louver unit 46 that louver unit is able to turn louver pieces UP, Down, Left, Right and able rotate directions when no use the pulling out function.

The side view 90 of 1st air outlet louver front section unit 45, showing the platform parts spring wire hook holes 50, 81, 83, 85, 44, 86, 87, and 89. The spring wire secure screws 47 to screw rotation direction 49 down press secure use to bite on the spring wire. The Lego type of (Female) holes 68, 70, 71, 72, 75, 76, 77, 78 designed for additional accessories function modules units with Lego type of (Male) pins to be plug into and connect with the platform.

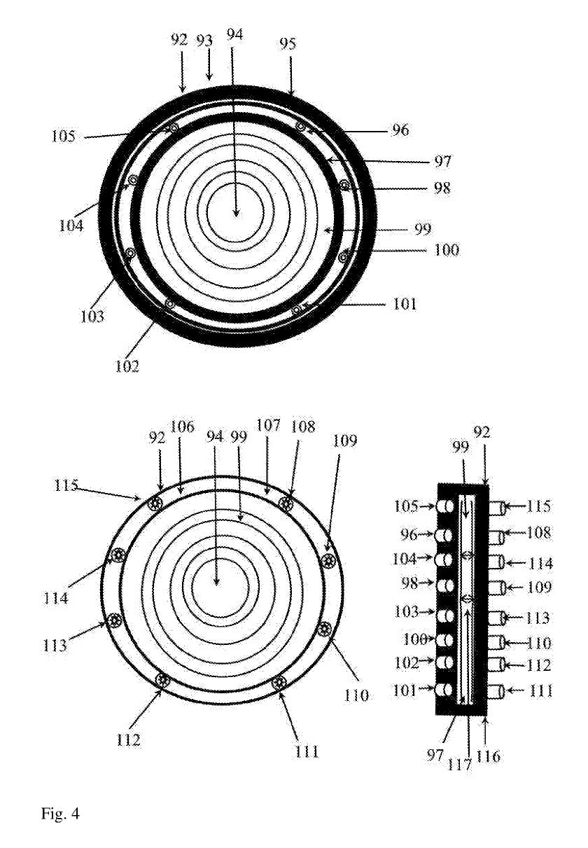

With reference to the drawings, as shown in FIG. 4 is showing the details parts of the additional air clean filter module platform 92.

The front side view 93 of the additional air clean filter module platform 92. The additional air clean filter module platform 92 has ring platform frame surface 95 and the air clean filter module platform 92 has air filter unit 99 and air flow center hole space 94. The front side surface 95 has the Lego type of (Female) holes 96, 98, 100, 101, 102, 103, 104, and 105 designed for additional accessories function modules units with Lego type of (Male) pins to be plug into and connect with the platform.

The back side view 106 of the additional air clean filter module platform 92. The air clean filter module platform 92 has air filter unit 99 and air flow center hole space 94. The back side surface 107 has the Lego type of (Male) pins 108, 109, 110, 111, 112, 113, 114, and 115 designed for additional accessories function modules units with Lego type of (Female) holes to be plug into and connect with the platform. Therefore, the additional air clean filter module platform 92 can plug connect with the 1st air outlet louver front section unit 45 front side Lego type of (Female) holes 68, 70, 71, 72, 75, 76, 77, 78.

The side view 116 shows the ring platform frame middle layer space 97 has assembled air filter unit 99 and filter can be metal mash air filter type method, and/or fibers layers air filter sheet method, the air clean filter unit has elastic force to fraction with the ring platform frame middle layer space 97 frame wall, so it keep filter inside, and when want to change air filter, just pull out and replace new one. If desire with perfume, or essential oil flavor smell, and/or air enhanced flavor perfume material (essential oil) 117 can add in the air clean filter layer to enhanced become the perfume platform module.

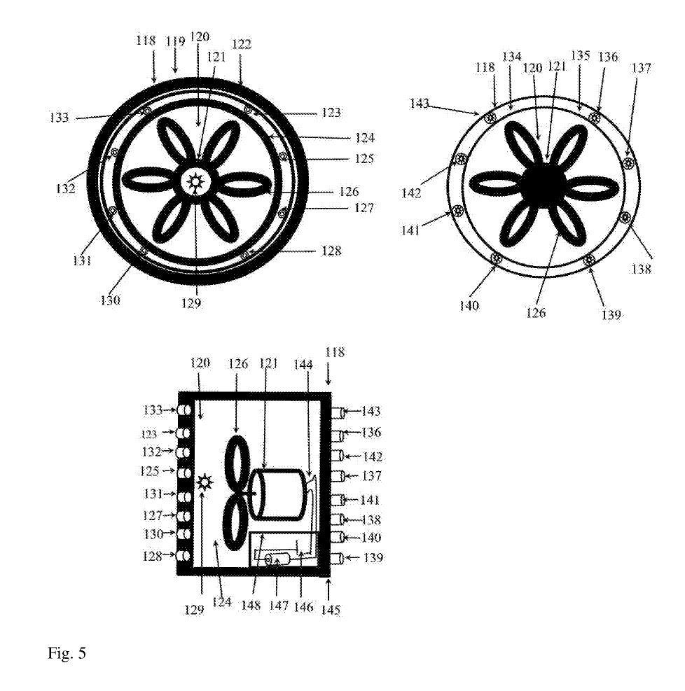

With reference to the drawings, as shown in FIG. 5 is a drawing showing the details parts of the additional battery powered motor fan module platform 118.

The front side view 119 of the additional battery powered motor fan module platform 118. The additional battery powered motor fan module platform 118 has ring platform frame surface 122 and the motor fan unit built in platform 118, has motor 121, motor fan 126 and air flow center hole space 120. The front side surface 122 has the Lego type of (Female) holes 123, 125, 127, 128, 130, 131, 132, and 133 designed for additional accessories function modules units with Lego type of (Male) pins to be plug into and connect with the platform.

The back side view 134 of the additional battery powered motor fan module platform 118. The additional battery powered motor fan module platform 118 has motor 121, motor fan 126 and air flow center hole space 120. The back side surface 135 has the Lego type of (Male) pins 136, 137, 138, 139, 140, 141, 142 and 143 designed for additional accessories function modules units with Lego type of (Female) holes to be plug into and connect with the platform. Therefore, the additional battery powered motor fan module platform 118 can plug connect with the 1st air outlet louver front section unit 45 front side Lego type of (Female) holes 68, 70, 71, 72, 75, 76, 77, 78. If desire to have air clean function, then can plug with the additional air clean filter module platform 92 and then plug with the 1st air outlet louver front section unit 45.

The side view 145 shows the battery powered motor fan module platform 118 has assembled motor 121, motor fan 126, and air flow center hole space 120 and built in battery power system 148 into platform, with battery 147, can be open battery cover to changed to new battery 147, battery circuit has switch On/OFF switch to control motor 121, and fan 126 rotate operation to increase the air flow become blow stronger wind. The LED light 129 unit can be add build into platform too, so when switch motor ON, LED light is ON too. LED light can be colors light.

The additional accessories platforms modules can be included a clean air filter platform module 92, and/or air enhanced flavor (essential oil) perfume material 117 layer platform module 92, and/or attached battery powered motor fan platform with switch ON/Off module 118, and/or attached battery powered LED light 129 platform with switch ON/Off module 118.

Using the Lego holes method on each platform front and back side to attached each accessories platform modules together and modules can be attached over layers on each other to add on the additional modules together that has Lego holes designed to plug and unplug with the 1st air outlet louver front section unit 45.

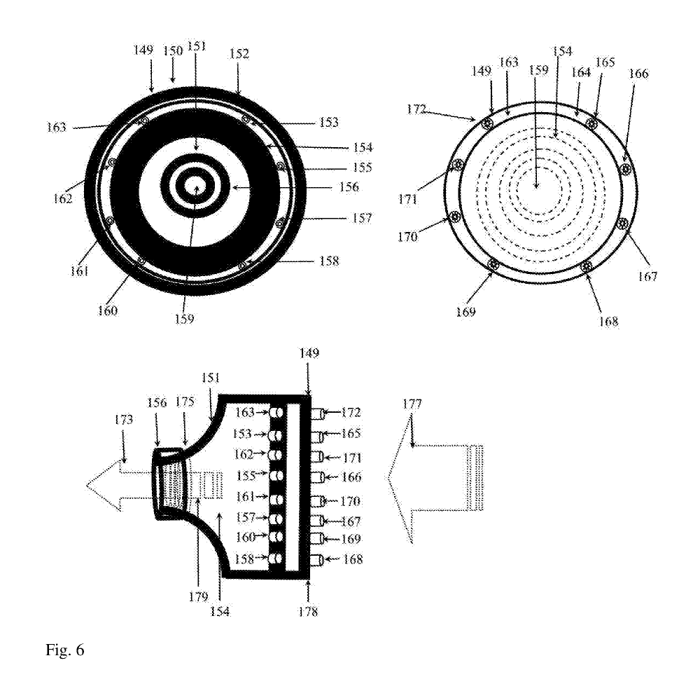

With reference to the drawings, as shown in FIG. 6 is a drawing showing the details parts of the additional wind cover with adjustable smaller to larger diameter length blow mouth hole module platform 149.

The device can attached the additional wind cover with adjustable smaller to larger diameter length blow mouth hole platform 149 to make the air flow stronger to softer.

The front side view 150 of the additional wind cover with adjustable smaller to larger diameter length blow mouth hole platform 149 has ring platform frame surface 152 and narrow shape cover 151, and screwier 156 can adjust diameter length blow mouth hole size and air flow center hole space 159. The front side surface 150 has the Lego type of (Female) holes 153, 155, 157, 158, 160, 161, 162, and 163 designed for additional accessories function modules units with Lego type of (Male) pins to be plug into and connect with the platform.

The back side view 163 of the additional wind cover with adjustable smaller to larger diameter length blow mouth hole platform 149 and has shows the inner space of wind narrow shape cover is forward and narrow the blow hole size of the air flow center hole space 159. The back side surface 164 has the Lego type of (Male) pins 165, 166, 167, 168, 169, 170, 171 and 172 designed for additional accessories function modules units with Lego type of (Female) holes to be plug into and connect with the platform. Therefore, the wind cover with adjustable smaller to larger diameter length blow mouth hole platform 149 can plug connect with the 1st air outlet louver front section unit 45 front side Lego type of (Female) holes 68, 70, 71, 72, 75, 76, 77, 78. and also to connect with other additional modules.

The side view 178 the wind cover with adjustable smaller to larger diameter length blow mouth hole platform 149 has narrow shape cover 151 with screw track 175, and screwier 156 by rotation can adjust diameter length blow mouth hole size and control the air flow center hole space 159, the air flow 177 travel through the platform space 154 and being narrow compress 179 has increase the to blowout air 173 stronger.

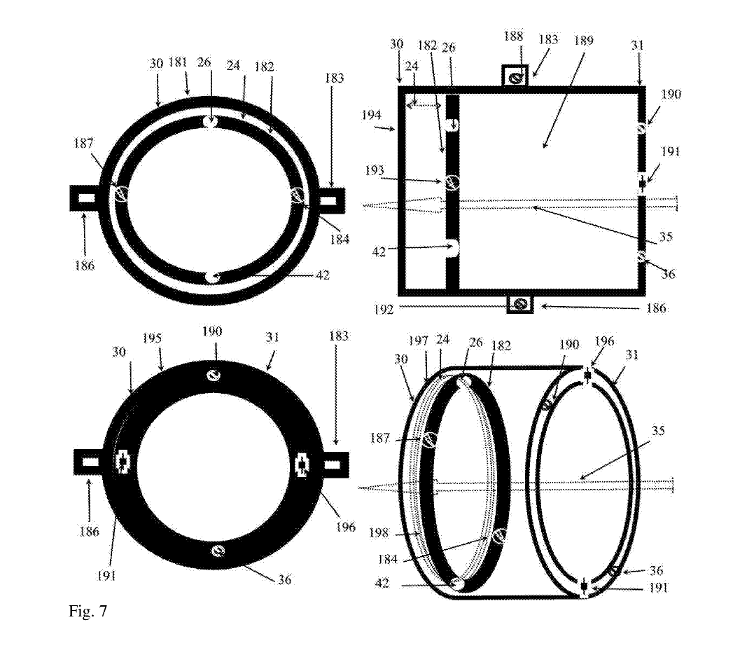

With reference to the drawings, as shown in FIG. 7 is a drawing showing the details parts of 2nd assemble session air outlet outer shell body 30.

The front end side view 181 of 2nd assemble session air outlet outer shell body 30 drawing shows 2nd front side platform surface 182 has pin holes 26 and 42 that use to connect with 1st front unit 45 locker pins 25 and 43 to insert into and by switch method or twist rotate action to locked or unlocked the 1st front section unit 45.

The 2nd front side platform surface 182 can add magnets 184 and 187 method use to connect with 1st unit 45 magnets. The body section 30 can select to add the outer body screw holes pieces 183 and 186 are to use for screw secure the Extendable Air Outlet Device installation with vehicle control panel.

The side view 194 show the hide distant space 24, the 2nd front side platform surface 182 is inner of the body shell 30 in a hide distance space 24, so most of the 1st session unit 45 will installed inside body shell 30 and have the louver 46 unit to appear on outside body shell 30, so when no pulling, passenger can use louver as regular air outlet style installed on driving control panel surface.

The 2nd front side platform surface 182 has shows the pin holes 26 and 42, and magnets 193. The outer body screw hole pieces 183 and 186, have screw holes inside 188 and 192.

The Vehicle Air Condition Air 35 blow through the body shell inner chamber space 189. The Extendable Air Outlet Device 23 can be built in Circle shape, Round shape, Square Shape, and Rectangle shape, the body shell 30 can be decided to built any body shell shape that meet the vehicle air outlet required.

The body shell platform end surface 31 has screw holes 190 and 36, and locker gaps to use connect The 4th bottom base platform unit 32 assembled installation.

The back side view 195 of 2nd assemble session air outlet outer shell body 30, on The body shell platform end surface 31 can select design the secure installation method by has screw holes 190 and 36, and/or locker gaps 191, and/or 196, and/or the outer body screw hole pieces 183 and 186.

The back side in 45 degree angle view 197 of 2nd assemble session air outlet outer shell body 30 has design to choose using screw track gap 198 method to rotate it into to be install the of 2nd assemble session air outlet outer shell body 30 with vehicle control panel where the air outlet hole position with opposite screw track.

2nd assemble session air outlet outer shell body 30 can be press it into the vehicle air outlet hole with PVC pieces plastic elastic force to hold bite on the screw track as gap locked for installation too.

The Extendable Air Outlet Device 23 is installed on driving control panel and not being pulling out, the vehicle air condition system air 35 will come in from the bottom base hole 33 though the cylinder pipe 28 to reach out the 1st air outlet louver front section unit 45 and blow out the air 48.

The 1st front unit will insert into the 2nd session connect distant 24 to the inner platform surface.

The 4th bottom base platform unit 32 is fixed installed by screws 36 on the body shell platform end surface 31 to connect with the 2nd outer shell body 30.

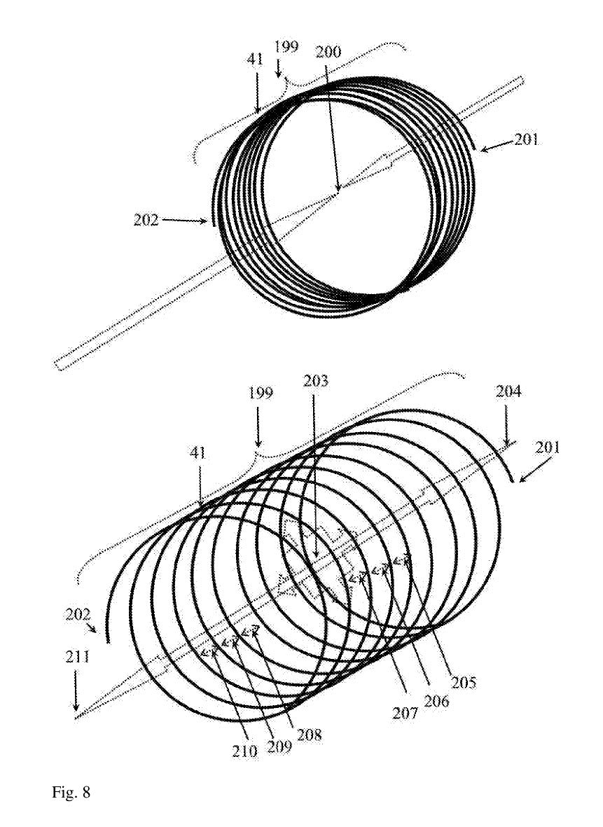

With reference to the drawings, as shown in FIG. 8 is a drawing showing the Helical spring 41. showing the Helical spring 41 has character to shrink back to the short length 199 and try close to its each spring ring gaps. The helical spring 41 can be similar like Slinky with a little bit spring wire shrink back force 200. When the helical spring 41 is being pulling out force 204 and 211, the spring has character of easy to bending ability 203 in all direction, and when release the pulling force 204 and 211, its spring tiny shrink back force 200 will help to gilding the wind tunnel tube 27 back to storage over cylinder shape pipe 28 of the 4th bottom base platform unit 32.

The one end of helical spring 201 will be secure installed with The 4th bottom base platform unit 32, so when is pulling out force 211 applied on spring wire end 202 and the force 204 due to the spring wire end 201 installed with the 4th bottom base platform unit 32, the result will be increase longer spring length 199 and increase the gap length between each spring ring gap length 205, 206, 207, 208, 209, and 210. So, the wind tunnel tube 27 can be extended its length and moving smoothly, and also the wind tunnel tube can be bending able in any position of tube.

When passenger finish and put back the 1st front session unit 45 to 2nd front side platform surface 182 of the 2nd assemble session air outlet outer shell body 30, The helical spring tiny inner shrink back force 200 will help gilding the wind tunnel tube back on over cylinder pipe 28 to store in proper position within the body wind tunnel tube storage chamber space.

The spring strength character can also choice select to have shrink back together ability 200 as nature status with no force 200 pulling back spring. When passenger want to put 1st air outlet louver front unit back, with the spring shrink back force 3 can help to retracts the wind tunnel tube to storage

When that using spring to construct an extendable wind tunnel tube system 27, the 3rd assemble section components parts of the Extendable Air Outlet Device, the spring's force strength and character can be selected to choice depends on design

In some design ways need that if want to have select use the stronger helical spring 41 string that could use bending and stay like such as bendable like desktop lamp neck and make the 1st front session air outlet unit 45 stay in the certain space position that passenger wanted.

For the best application design of the Extendable Air Outlet device 23, the helical spring 41 best design choose can be select similar like Slinky, the spring strength that is easy to be pulling out force 200 and moving around, So, passenger total control the wind tunnel tube can be extended and the helical spring 41 apply tiny retract back force 200, having shrink back together ability to make easy to put wind tunnel tube 27 back.

It can depends on the design need and where the device location will be installed inside the vehicle interior room, if need helical spring 41 use spring like Slinky, and/or have shrink back force and/or have bendable stronger strength spring.

For this invention application demo is select to use Helical spring 41 similar like Slinky and with little bit spring shrink back force 200.

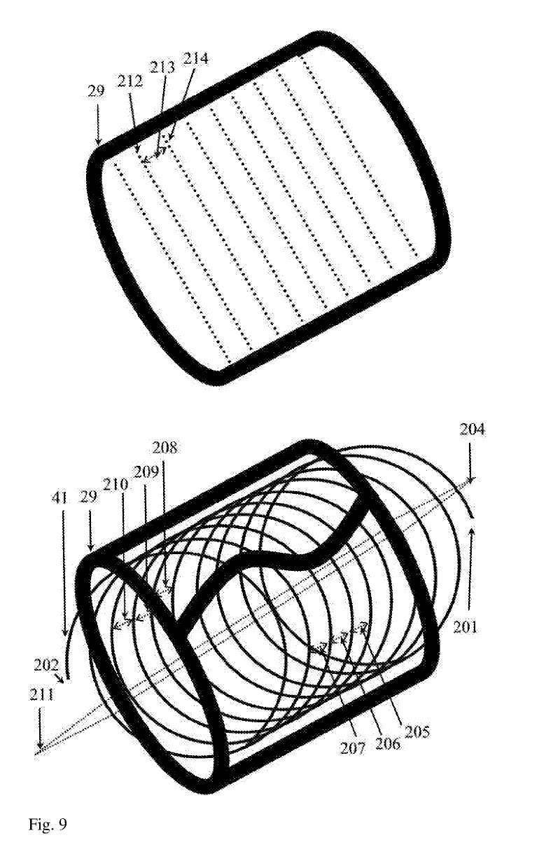

With reference to the drawings, as shown in FIG. 9 is a drawing showing the Helical spring has cover material sheet 29 to be wind tunnel tube 27.

The cover material sheet 29 can rebuilt the spring wire installed gap lines 212, and 214 in a tiny gap formation that will make fit the attached with helical spring 42 each wire ring width easily to fit and position with spring wire and have secure attached the cover material sheet 29 with the helical spring 41.

On the helical spring 41 has cover material sheet 29, the cover material sheet 29 can be by glue a PVC sheet, paper, or elastic rubber, elastic clothe, or spandex fiber cloth material, or can be use by sewing method plastic PVC leather sheet, or clothe fiber, or leather, or can be use by made a thin plastic layer (PVC sheet) in “U” formation attached on each spring rings. When the helical spring 41 retract back to store in the 3rd assemble session space, between each spring ring gap is closer, because the gaps space 205, 208, 206, 209, 207, and 210 gap will shorter length, so the cover material sheet 29 on the gap area such as between gap line 212 and 214, the cover sheet gap area 213 will into “U” 39 formation. The helical spring 41 can be made by metal material and plastic material. When select helical spring 41 by plastic material and the cover material sheet 29 can also use plastic too, so the wind tunnel tube can be manufactured by using 3D printing method to print the thin “U” shape 39 cover elastic plastic sheet 29 and the plastic helical spring 41 as one wind tunnel tube unit 27.

The “U” formation 39 of cover material sheet 29 with helical spring 41, the helical spring each ring width can be 1 mm, so each 1 cm will have 10 spring wire rings session, if apply 2 cm of thin PVC sheet, or elastic rubber/spandex cloth fiber on the each wire ring between, then when the wind tunnel tube shrink back into “U” formation it will be 1 cm on each side. Therefore, for a helical spring 5 cm will have 50 wire rings×2 then the wind tunnel tube can flexible to be extended around 1 meter length.

Case 1 and 2 to shows calculations the wind tunnel tube flexible extendable length and chamber storage space is workable:

Case 1:

For example using helical spring (wire width 1 mm) spring diameter length 5 cm, and total helical spring is 5 cm width, so the spring wire could have around 1 mm×10×5=50 wire rings secession between. cylinder pipe diameter using 4.9 cm or less.

when to use 1 cm cover material sheet apply on each wire ring between gap,

1 cm×50=50 cm wind tunnel tube flexible extendable length.

The “U” formation folded then cover material sheet will be folded into 0.5 cm on each side. Plus the helical spring diameter length 5 cm, and total wind tunnel tube storage diameter length is 05 cm+5 cm+0.5 cm=6 cm diameter storage length, (because it is around cylinder pipe so 0.5 cm on the upside, and another 0.5 cm on the bottom side on cylinder pipe) and the cylinder pipe 28 diameter length can be 4.9 cm or less that fit well to the helical spring, and able to storage the system unit in a air outlet unit chamber space.

2 cm×50=100 cm wind tunnel tube flexible extendable length. (1 cm+5 cm+1 cm=7 cm diameter storage length)
3 cm×50-150 cm wind tunnel tube flexible extendable length. (1.5+5 cm+1.5 cm=8 cm diameter storage length),

Case 2:

If increase the helical spring 5 cm width to 10 cm width then 1 mm×10×10=100 wire rings secession between and reduce the helical spring diameter length 5 cm to 3 cm.

1 cm×100=100 cm wind tunnel tube flexible extendable length. (0.5+3 cm+0.5 cm=4 cm diameter storage length)
2 cm×100=200 cm wind tunnel tube flexible extendable length. (1 cm+3 cm+1 cm=5 m diameter storage length)
3 cm×100-300 cm wind tunnel tube flexible extendable length. (1.5 cm+3 cm+1.5 cm=6 cm diameter storage length)

In average wind tunnel tube length is workable for the vehicle room space as

Dryer In Vehicle usage purpose and can be installed fit into the Extendable Air Outlet Device.

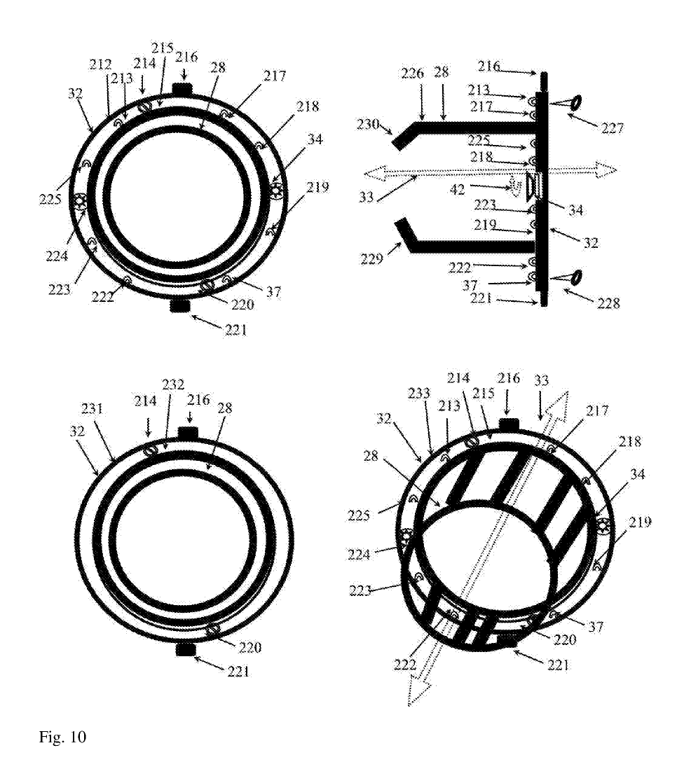

With reference to the drawings, as shown in FIG. 10 is a drawing showing the details parts of the 4th assemble session bottom base platform unit 32.

The front side view 212 of the 4th bottom base platform unit 32. On the bottom base front side surface 215 has parts includes the spring wire secure screws 34 and 224, and the spring wire hook holes 37, 217, 218, 219, 222, 223, 225, ad 213 and the base screw holes 214 and 220, and cylinder pipe 28, and base platform locker stick pieces 216 and 221.

The back side view 231 of the 4th bottom base platform unit 32. On the bottom base back side surface 232 has shows parts includes cylinder pipe 28 inner side and the base screw holes 214 and 220.

The base platform unit 32 can select chose the connect method by screw holes, and/or the locker stick pieces to installed on the body shell platform end surface 31 to connect with the 2nd assemble session air outlet outer shell body 30.

The side view 226 of the 4th bottom base platform unit 32. drawing shows the cylinder pipe mouth can build in narrow down smaller size than pipe width for 2 reasons. The 1st reason the narrow pipe width to make the wind tunnel tube 27 to gilding retract make properly storage the helical spring in order manner over on the cylinder pipe 28. The 2nd reason to design for increase the air flow strength that the air flow coming from the bottom base hole 33.

The spring wire will into the spring wire hook holes 37, 217, 218, 219, 222, 223, 225, and 213, and then screw down action 42 the spring wire secure screws 34 to bite down the helical spring 41 and secure installed. The screws 227 and 228 will insert to screw holes 214 and 220 to screw tight with the on the body shell platform end surface 31, and also can select to use and base platform locker stick pieces 216 and 221 to pin lock with the on the body shell platform end surface 31 connect with the 2nd assemble session air outlet outer shell body 30.

The front side in 45 degree view 233 of the 4th bottom base platform unit 32. drawing shows the cylinder pipe 28 in length view with the front side platform 215 and all other the 4th session parts mentioned above.

The screws 227 and 228 will insert to screw holes 214 and 220 to screw tight with the on the body shell platform end surface 31, and also can select to use and base platform locker stick pieces 216 and 221 to pin lock with the on the body shell platform end surface 31 connect with the 2nd assemble session air outlet outer shell body 30.

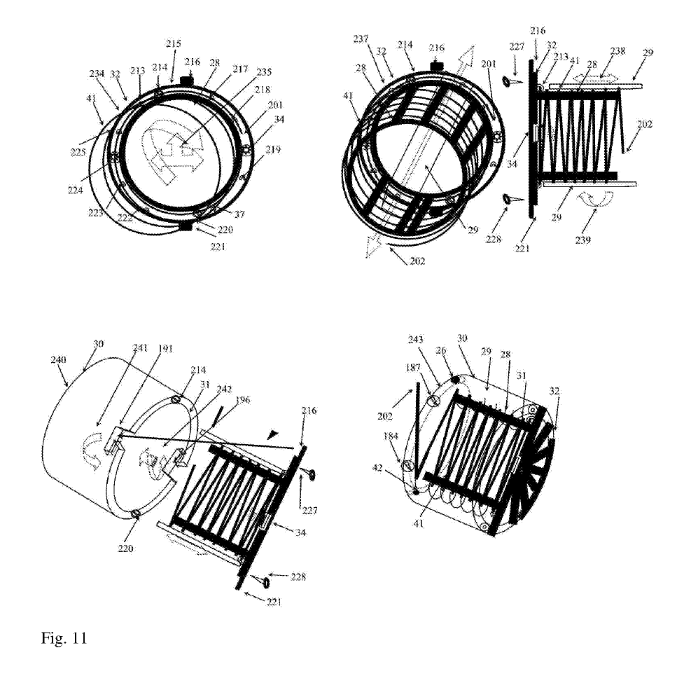

With reference to the drawings, as shown in FIG. 11 is a drawing showing the details parts assemble the 3rd wind tunnel tube system unit 27 with the 4th assemble session bottom base platform unit 32 and then insert into the 2nd assemble session air outlet outer shell body 30.

The front view 234 drawing shows the assemble procedure steps, 1st step is helical spring wire 201 to insert into the spring wire hook holes 37, 217, 218, 219, 222, 223, 225, and 213, and then will be screw down action 42 the spring wire secure screws 34 and 224 to bite down the helical spring 41 and secure installed with the 4th bottom base platform 32.

The front side in 45 degree view 237 drawing shows the 2nd step that arranged the wind tunnel tube has secured installed with the 4th assemble session bottom base platform unit 32 and the wind tunnel tube has storage over on the cylinder pipe 28.

The bottom side up in 225 degree view 240 drawing shows the 3rd step that insert the assembled 3rd wind tunnel tube 27 and the 4th assemble session bottom base platform unit 32 is insert into the into the 2nd assemble session air outlet outer shell body 30 chamber space.

The drawing shows the 4th step that using the bottom locker gap stick pieces 216 and 221 to installed with the 2nd body platform 31 locker gaps 191, and 196, and the screws 227 and 228 into screw holes 214 and 220 to assemble all 3 session units (2nd, 3rd, and 4th) together.

The bottom view in 225 degree view 243 drawing to show the assembled 2nd, 3rd and 4th unit of the Extendable Air Outlet Device 23.

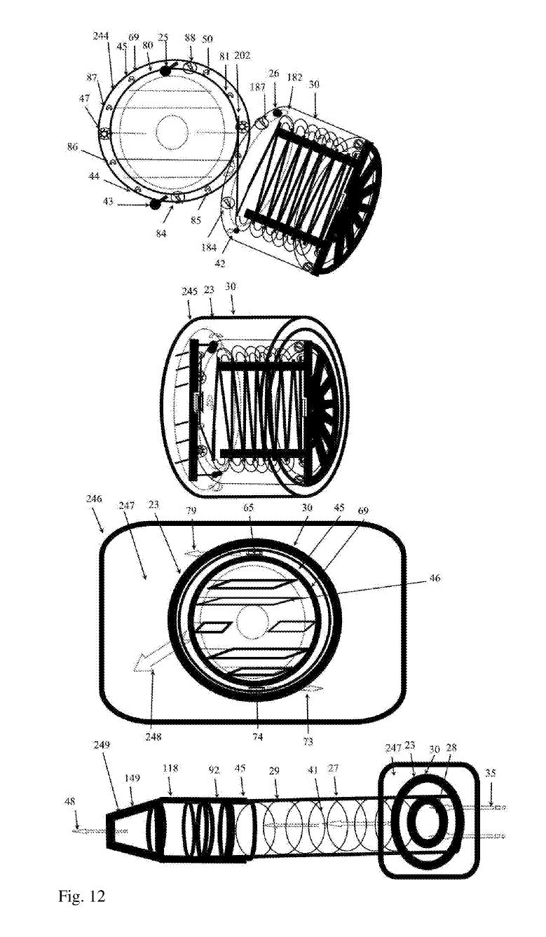

With reference to the drawings, as shown in FIG. 12 is a drawing showing the details parts assemble The 1st air outlet louver front section unit 45 and the ring platform frame surface 69 backside surface 80 has parts to secure installed with and by connect helical spring 41 wire end 202 to included each spring wire hook holes 50, 81, 83, 85, 44, 86, 87, and 89. The spring wire secure screws 47 and 82 to screw rotation direction 49 down press secure use to bite on the spring wire. and then locker pins 25 and 43 to insert into 2nd assemble session air outlet outer shell body 30 pin holes 26 and 42 by twist rotate action to locked or unlocked the 1st front section unit 45 and 2nd assemble session air outlet outer shell body 30.

The completed Extendable Air Outlet Device 23 has embed with the 3rd wind tunnel tube system unit 27 that have already installed with the 4th assemble session bottom base platform unit 32 and the 2nd assemble session air outlet outer shell body 30 is the outer shell body to hold all the units together to be a completed Extendable Air Outlet Device 23 assembled shows in drawing view 245.

The installed view 246 on the vehicle driving control panel surface 247 shows the completed Extendable Air Outlet Device 23 installed and the louver design 46 attached appear on the driving control panel surface 247 as a regular air outlet appearance. Passenger can click the locker pin switchers 65, 74 to move left 79, right 73 direction to unlock the 1st air outlet louver front section unit 45 with The 2nd assemble air outlet outer shell body 30 will stay in control panel surface 247 installed position, and the front section unit 45 can be pulling out in direction 248.

The drawing view 249 to show the Extendable Air Outlet Device 23 is activated, passenger is pulling out the 1st air outlet front section unit 45 and the wind tunnel tube 27, helical spring 41 with cover material sheet 29 that storage over around the cylinder pipe 28 system is keeping support to extent the tube length to allow passenger freely moving the 1st session unit 45 around in any direction points.

Passenger can decide add additional function modules such as air clean filter module platform 92, and/or battery powered motor module platform 118, and/or wind cover with adjustable smaller to larger diameter length blow mouth hole platform 149.

The completion of the Extendable Air Outlet Device 23 embed an extendable wind tunnel tube system 27 to use vehicle's air condition system air 35 as Dryer In The Vehicle. The 1st air outlet section unit 45 of Extendable Air Outlet Device's 23 can be moving freely as Dryer In Vehicle and directly blow air 48 on any directions to surround area and also directly point on passenger body area even while they are in sitting position.

To manufacture the Extendable Air Outlet Device's 23 can be select to use the 3D printing method to made the whole device at once without need separated parts to assembled together. For example all parts are use PVC plastic material, then have the air outlet drawing in 3D printing files, and use the 3D printer to print out the Extendable Air Outlet Device's 23, and then wash out the 3D filling materials to enable to moving parts inside the 3D printed Extendable Air Outlet Device's 23. This method is most useful for customer who want to change their car air outlet, and can be drawing the 3D file of Extendable Air Outlet Device's 23 according the customer car model and also which air outlet they want to change, then having the specification of the air outlet model and drawing with the session parts in 3D printing schematic drawing file, then direct to use the 3D printer to print out the new Extendable Air Outlet Device's 23 for them to change it.

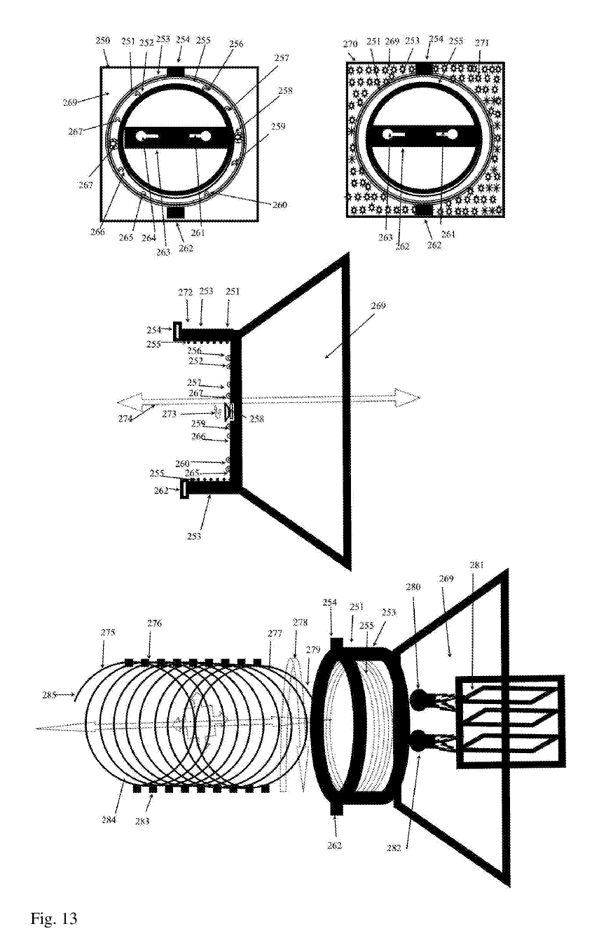

With reference to the drawings, as shown in FIG. 13 is a drawing showing the 2nd style of details Extendable Air Outlet Device can be build, the 2nd style is simplest platform as Portable Extendable Air Outlet Device platform 251 that attached on air outlet as external attachment device.

The drawing view 275 has show the wind tunnel tube 284 is constructed by cover material sheet 276 in “U” formation 283. The cover material sheet 276 can be made by thin plastic sheet, PVC sheet, Elastic Rubber material cloth, Spandex cloth, Paper, PVC leather, leather materials to glue, or by sewing, or make thin plastic sheet in “U” formation 283 to built with the helical spring 277 or use 3D print method print out together as 1 unit.

The front view 250 of the Portable Extendable Air Outlet Device base platform 251 is Cup shape has round wall 253 circle raise above the base platform 251 surface dimension. On the base platform front side surface has spring wire hook holes 252, 256, 257, 259, 260, 265, 266, and 267. The spring wire secure screws 258 and 267. The wind tunnel tube 284 helical spring wire end 279 will insert into the spring wire hook holes and then the spring wire secure screws 258 and 267 to screw rotation direction 273 down press secure use to bite on the spring wire to installed the wind tunnel tube 284 with the base platform 251.

The inner side surface of raise round wall 253 has screw track 255 can be use to rotate 278 the wind tunnel tube spring wire 279 into the screw track 255 to secure the wind tunnel tube 284 with the base platform 251.

The front side view 250 drawing show the front side surface has built addition suction cups mat sheet 269 that use to cover around on the vehicle's air outlet mouth area 281. The base platform 251 ring center position can select to design build included a louver install plate 263 with bite teethes holes 261 and 264. The louver biting teethes 280 and 282 will insert into the bite teethes holes 261 and 264 on the base platform 251 and then use the louver biting teethes 280 and 282 to bite on the air outlet 281 louver to install the Potable Extendable Air Outlet Device base platform 251 onto the vehicle air outlet area 281 an also passenger press suction cups mat 269 to make air seal holding.

The back side view 270 of the base platform 251 drawing shows the suction cup mat 269 has many tiny suction cups 271. Passenger put the base platform 251 on the vehicle's air outlet 281 and then spread out the suction cups mat 269 around the outlet mouth area 281, then to press down tiny suction cups 271 on the around outlet area 281 to make an air seal holding to connection keeping air to keep flow into the wind tunnel tube 284.

The front view 250 of the Portable Extendable Air Outlet Device base platform 251 has show the base platform 251 has the outer body screw hole pieces 254 and 262.

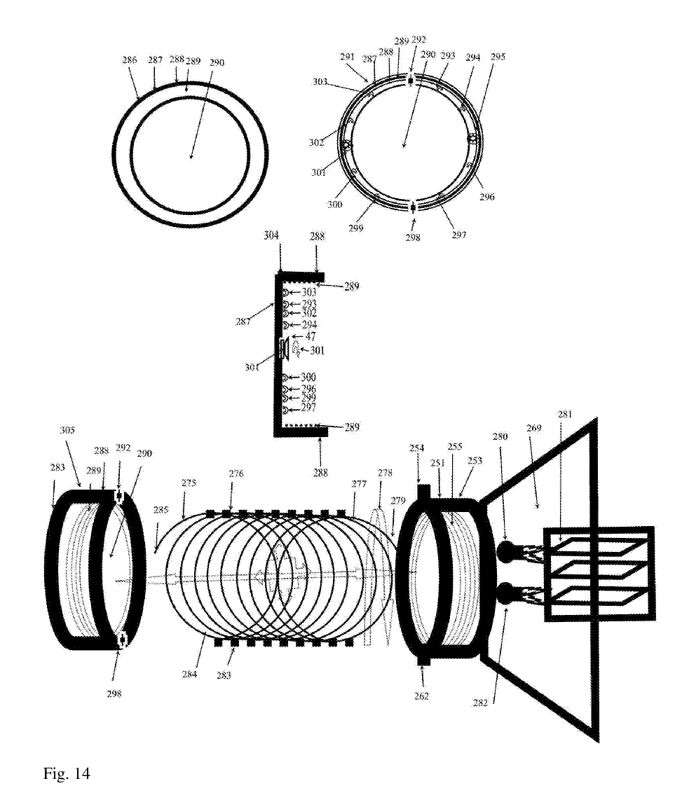

With reference to the drawings, as shown in FIG. 14 is a drawing showing the 2nd style of details Extendable Air Outlet Device can be build, the front base platform 287 of Portable Extendable Air Outlet Device platform that attached on wind tunnel tube 284.

The front view 286 of the front base platform 287 of Potable Extendable Air Outlet Device. The front base platform surface 289 and ring platform center hole space 290.

The back view 291 of the front base platform 287 is Cup shape has parts includes front wall 288 circle raise above the front base platform 287 surface dimension. On the front base platform back side surface has spring wire hook holes 293, 294, 296, 297, 299, 300, 302, and 303. The spring wire secure screws 295 and 301. The wind tunnel tube 284 helical spring wire end 285 will insert into the spring wire hook holes and then the spring wire secure screws 295 and 301 to screw rotation direction down press secure use to bite on the spring wire to installed the wind tunnel tube 284 with the front base platform 287.

On the side view 305 has shows the front base platform 288 has locker gaps 292 and 298. The base platform 251 has The outer body screw hole pieces 254 and 262. When passenger finish, and push back to connect into the locker gaps 292 and 298 and twist both Cup shape platform in opposite direction to secured connected both base platform 251 and front base platform 287 Cup shape platforms together when no use the Potable Extendable Air Outlet Device.

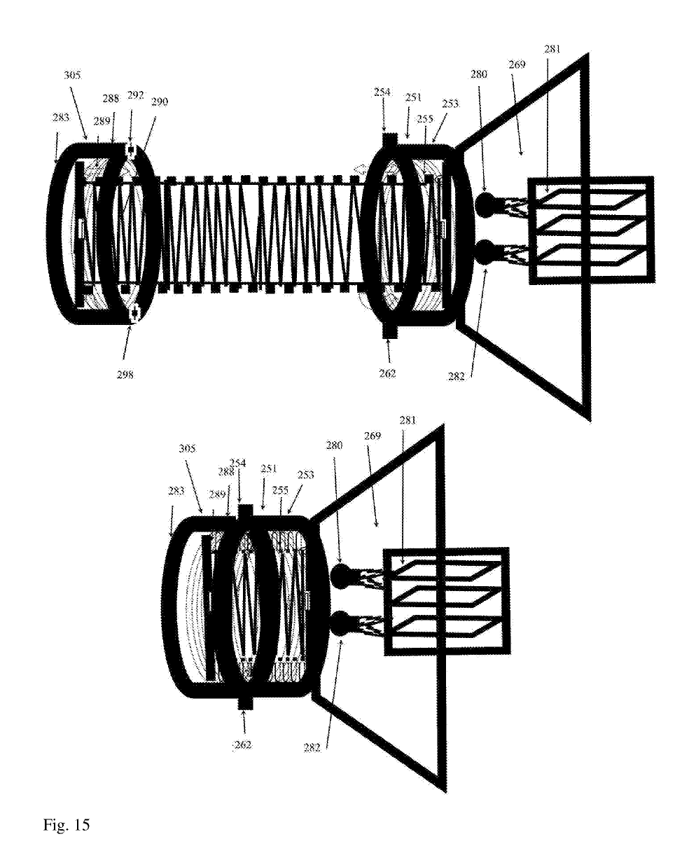

With reference to the drawings, as shown in FIG. 15 is a drawing showing the completion of 2nd style Portable Extendable Air Outlet Device platform that has front base platform 288 and base platform 251 in between ha attached on wind tunnel tube 284. Passenger is able to pulling out in length, and also can push back and twist action to close the device in 1 unit box.

The view 305 of completion of Potable Extendable Air Outlet Device is being pulling in longer distance, the wind tunnel tube 284 keeping increase length to pass through the air from air outlet 281 to the front bas platform 288 and blow air out. Passenger is able moving the front base platform freely and direct point where wanted to.

In view 305 drawing shows, when finish, passenger can push back, the wind tunnel tube will retract back and match push the locker gaps 292 and 298 into The outer body screw hole pieces 254 and 262 on the base platform 251 and do twist action on both platforms in opposite direction to secured connected both base platform 251 and 288 together as 1 unit box, and when next time passenger want to use Potable Extendable Air Outlet Device again, simple hand hold the device and do twist action to unlock to open the box and attached on the vehicle air outlet, and use the use Potable Extendable Air Outlet Device as Dryer In Vehicle and Transportation.

I claim:

1. The completed Extendable Air Outlet Device embed an extendable wind tunnel tube system to use air condition system as Dryer In The Vehicle and Transportation,
The Extendable Air Outlet Device has 4 assemble session units parts, and each assemble session unit use components includes,
The 2nd assemble session unit is Extendable Air Outlet Device Outer Shell Body unit 30 to hold the 1st assemble the air outlet front unit 45, and the 2nd assemble the wind tunnel tube unit 27, and the 4th assemble The bottom base platform unit 32 together.
The Extendable Air Outlet Device has embed an extendable air tube system to allow passenger is able to remove the 1st air outlet front section and with its embedded extendable air tube enable for pulling out of the air outlet's body shell unit 30.

2. According to claim 1 The bottom base platform 32 is in frame formation with center hole space to let vehicle air condition air blow in Extendable Air Outlet Device Outer Shell Body unit 30.
On the front side of the bottom base platform 32 has built cylinder shape pipe on the platform frame and the air blow thought the cylinder pipe to the front.

3. According to claim 1 The wind tunnel tube unit 27 is constructed by a helical spring cover with thin material sheet to become flexible and extendable wind tunnel tube 27.
One helical spring end of the wind tunnel tube 27 is fixed installed on the bottom base platform unit 32 front surface side and the wind tunnel tube is storage over around the cylinder pipe built on the bottom base platform 32 front side surface.

4. According to claim 1 The bottom base platform unit 32 in frame formation with center hole space to let air condition Hot/Cold air blow thought it and On the front side platform surface with spring wire hook holes to hold wind tunnel tube helical spring wire, and has the spring wire secure screws to screw down press secure use to bite on the spring wire to secure installed wind tunnel tube with The bottom base platform unit 32, and the bottom base platform unit 32 has use screw holes to screw and/or twist gap locker method installed with back end surface of the Extendable Air Outlet Device Outer Shell Body unit 30.

5. According to claim 1 the 1st assemble air outlet front unit 45, in frame formation with center hole space to let air condition Hot/Cold air blow thought it and On the back side platform surface with spring wire hook holes to hold wind tunnel tube helical spring wire, and has the spring wire secure screws to screw down press secure use to bite on the spring wire to secure installed wind tunnel tube with the 1st assemble air outlet front unit 45, and the 1st assemble air outlet front unit 45 has use switch locker pins and/or magnets method to connect with front end surface of the Extendable Air Outlet Device Outer Shell Body unit 30.

6. According to claim 1 The 1st assemble air outlet front unit 45 is in frame formation with center hole space to let the vehicle air condition air blow thought out of the Extendable Air Outlet Device to the vehicle room space.
One the other helical spring end of the wind tunnel tube 27 is fixed installed on the 1st assemble air outlet front unit 45 backside surface side and the wind tunnel tube is attached with the unit 45 backside surface frame.

7. According to claim 1 The 1st assemble air outlet front unit 45 can be separated from the Extendable Air Outlet Device Outer Shell Body unit 30 and while the front section unit 45 can be pulling out with the wind tunnel tube 27 attached on one side and blow the vehicle air condition system air out.

8. According to claim 1 The Extendable Air Outlet Device 23 is installed on the vehicle's passenger room surface and vehicle's driving control panel surface as air outlet to blow out the vehicle's air condition hot temperature heater air, cold air condition air out to redistribute air outlet's blow directions the cold or hot air from vehicle's air condition system to allow passenger use the Extendable Air Outlet Device as Dryer In The Vehicle.

9. According to claim 1 The Extendable Air Outlet Device 23 allow passenger to move the unit 45 freely blow air in any direction and position around the vehicle cabin, vehicle's passenger room space within the wind tunnel tube extendable length range space area and use as Dryer In Vehicle for passenger hand hold air outlet and point to direct blow air on passenger's body area hair, head, face, shoulder, hands, upper body, the lower body area 15, under belly area 16, and between legs area 17, and also can point air blow to chairs, seats, windows, any objects within the wind tunnel extend reachable distance.

10. According to claim 1 The 1st assemble air outlet front unit 45 front side platform surface has Lego type of (Female) holes and allow to be attached for additional accessories function modules units platform with Lego type of (Male) pins to be plug into and connect with the platform The 1st assemble air outlet front unit 45.

11. According to claim 8 The additional accessories function modules units platform can be the additional air clean filter module platform 92, the perfume platform module platform, the additional battery powered motor fan module platform 118, LED light module platform, and the additional wind cover with adjustable smaller to larger diameter length blow mouth hole module platform 149.

12. According to claim 10 The additional accessories function modules units back side platform surface has surface has Lego type of (Female) holes and front side of platform has Lego type of (Male) pins by using the Lego holes method on each platform front and back side to attached each additional accessories platform modules together and modules can be attached over layers on each other to add on the additional modules together that has Lego holes designed to plug and unplug with the 1st air outlet louver front section unit 45.

13. According to claim 1 When the wind tunnel tube's 27 helical spring 41 is being pulling out force 204 and 211, the spring has character of easy to bending ability 203 in all direction, and when release the pulling force 204 and 211, its spring tiny shrink back force 200 will help to gilding the wind tunnel tube 27 back to storage over cylinder shape pipe 28 of the 4th bottom base platform unit 32.

14. According to claim 1 when is pulling out wind tunnel tube 27 that is installed with the 4th bottom base platform unit 32, the result will be increase longer wind tunnel tube length 199 and increase the helical spring gap length between each spring ring gap length. So, the wind tunnel tube 27 can be extended its length and moving smoothly, and also the wind tunnel tube can be bending able in any position of tube.

15. According to claim 1 The wind tunnel tube 27 is using helical spring 41 has cover material sheet 29, the cover material sheet 29 can be by glue a PVC sheet, paper, or elastic rubber, elastic clothe, or spandex fiber cloth material, or can be use by sewing method plastic PVC leather sheet, or clothe fiber, or leather, or can be use by made a thin plastic layer (PVC sheet) in “U” formation attached on each spring rings.

16. According to claim 1 The Extendable Air Outlet Device 23 can be built in Circle shape, Round shape, Square Shape, and Rectangle shape, the body shell 30 can be decided to built any body shell shape that meet the vehicle air outlet required.

17. According to claim 1 The Extendable Air Outlet Device 23 is installed on driving control panel and when not being pulling out, the vehicle air condition system air 35 will come in from the bottom base hole 33 though the cylinder pipe 28 to reach out the 1st air outlet louver front section unit 45 and blow out the air 48 as normal vehicle air outlet.

18. According to claim 1 The helical spring 41 will help to retract wind tunnel tube 27 back by each spring ring by ring 38 and 40 and folded the cover material sheet 29 in to “U” 39 formation and have well managed properly to store the wind tunnel tube 27 over around the cylinder pipe 28 for the next time pulling out.

18. According to claim 1 the Extendable Air Outlet Device's 23 can be select to use the 3D printing method to made the whole device at once without need separated parts to assembled together. For example all parts are use PVC plastic material, then have the air outlet drawing in 3D printing files, and use the 3D printer to print out the Extendable Air Outlet Device's 23, and then wash out the 3D filling materials to enable to moving parts inside the 3D printed Extendable Air Outlet Device's 23.

19. The completed Portable Extendable Air Outlet Device platform 251 attached on air outlet as external attachment device system to redistribute air outlet's blow directions the cold or hot air from vehicle's air condition system as Dryer In The Vehicle and Transportation.
Portable Extendable Air Outlet Device platform has 3 assemble session units parts, and each assemble session unit use components includes,
The 1st assemble session unit is Base Platform 251 in frame formation with center hole space to let air condition Hot/Cold air blow thought it and On the front side platform surface with spring wire hook holes to hold wind tunnel tube helical spring wire, and has The spring wire secure screws to screw down press secure use to bite on the spring wire to secure installed wind tunnel tube with base platform 251 and the front side surface has built addition suction cups mat sheet 269 that use to cover around on the vehicle's air outlet mouth area 281. The base platform 251 ring center position can select to design build included a louver install plate 263 with bite teethes holes 261 and 264. The louver biting teethes 280 and 282 will insert into the bite teethes holes 261 and 264 on the base platform 251 and then use the louver biting teethes 280 and 282 to bite on the air outlet 281 louver to install the Potable Extendable Air Outlet Device base platform 251 onto the vehicle air outlet area 281 an also passenger press suction cups mat 269 to make air seal holding.
The 2nd assemble session unit is the Wind tunnel tube 284 is constructed by cover material sheet 276 in “U” formation 283. The cover material sheet 276 can be made by thin plastic sheet, PVC sheet, Elastic Rubber material cloth, Spandex cloth, Paper, PVC leather, leather materials to glue, or by sewing, or make thin plastic sheet in “U” formation 283 to built with the helical spring 277 or use 3D print method print out together as 1 unit.
The 3rd assemble session unit is the Front base platform 287 in frame formation with center hole space to let air condition Hot/Cold air blow thought it and On the back side platform surface with spring wire hook holes to hold wind tunnel tube helical spring wire, and has The spring wire secure screws to screw down press secure use to bite on the spring wire to secure installed wind tunnel tube with front base platform 287.
Flexible and extendable wind tunnel tube is constructed by helical spring with cover material sheet

20. According to claim 19 the Potable Extendable Air Outlet Device. push back wind tunnel tube back to inside space of the Front base platform 287 and Base platform 251 and use the twist gap locker in opposite direction to closed the Cup shape platform secured connected both base platform 251 and front base platform 287 Cup shape platforms together with wind tunnel tube inside the chamber.
